(19) United States
(12) Patent Application Publication
(10) Pub. No.: US 2012/0007946 A1
(43) Pub. Date: Jan. 12, 2012

(54) HOLOGRAM REPRODUCTION IMAGE PROCESSING APPARATUS AND PROCESSING METHOD

(75) Inventors: Shigeyuki Baba, Tokyo (JP); Akira Shirakura, Tokyo (JP); Shinichi Yoshimura, Tokyo (JP); Kazuki Sakamoto, Tokyo (JP)

(73) Assignees: SONY DADC CORPORATION, Tokyo (JP); SONY CORPORATION, Tokyo (JP)

(21) Appl. No.: 13/157,425

(22) Filed: Jun. 10, 2011

(30) Foreign Application Priority Data
Jun. 30, 2010 (JP) 2010-149571

(51) Int. Cl. H04N 5/89

(52) U.S. Cl. 348/40; 348/E07.001

(57) ABSTRACT

A holographic reproduction image processing apparatus includes: a detecting section detecting the luminance of a plurality of pixels in an area of a holographic reproduction image extending in a direction substantially orthogonal to a direction in which the image has luminance variation; and an image processing section correcting the luminance variation according to luminance information supplied from the detecting section.

### FIELD

The present disclosure relates to a hologram reproduction image processing apparatus and a hologram reproduction image processing method.

### BACKGROUND

Holograms are used for authentication of credit cards, identification cards, and the like because holograms can be displayed as stereoscopic images of such objects. In practice, embossed holograms having surface irregularities recorded using an interference film are widely used. However, embossed holograms have a problem in that they are liable to forgery. On the contrary, it is very difficult to forge Lipman holograms which are obtained by recording an interference film as refractivity differences in the film. The reason is that advanced techniques are required to create an image to be recorded and that it is difficult to obtain recording materials. Depending on hologram producing methods, Lipman holograms are categorized into laser holograms which are obtained by irradiating an object with a laser and holographic stereograms which are recorded based on parallax images obtained from a multiplicity of view points.

In general, the production of a Lipman holographic stereogram includes a content creating step including processes such as acquisition of images and edition of the acquired images, a hologram master creating step, and a replication (mass-production) step. An image is acquired by imaging an object or using computer graphics. Each of a plurality of images obtained at an image editing step is converted into a rectangular image using, for example, a cylindrical lens. Interference fringes generated between object beams of the images and a reference beam are sequentially recorded on a hologram recording medium as holographic elements to create a master. The hologram recording medium is tightly fitted to the master and illuminated with laser light to replicate the hologram.

Such a hologram includes rectangular holographic elements which are pieces of image information obtained by imaging an object from different viewing points aligned in the horizontal direction sequentially and which are sequentially recorded in the horizontal direction. When a person views the hologram with both eyes, two-dimensional images viewed by the left and right eyes respectively are slightly different from each other. Thus, the viewer feels parallax, and a three-dimensional image is therefore reproduced.

The applicant has proposed a hologram replicating apparatus and method which allow additional information on a hologram to be recorded at the same time when the hologram is replicated. When a hologram replicated using the method is viewed, character information and bar code information recorded on a holographic basis can be reproduced depending on the viewing angle. For example, a label having a holographic image recorded thereon may be attached to a product, and the holographic image reproduced from the label may be read. The reproduced holographic image may be processed to be used for authentication. Information which is read as binary data such as a serial number or bar code is frequently recorded as a holographic image of this type. It is often desired to render a holographic reproduction image such that the image is not only perceived by human eyes but also photo-electrically converted by an imaging apparatus into a machine-readable form.

However, a holographic reproduction image may suffer from luminance variation attributable to the stability of the laser used for reproduction and the contraction of the recording material, and errors can therefore occur when the image is read. As a solution to such a problem, according to the technique disclosed in JP-A-2006-343702 (Patent Document 1), a reference beam used for reproduction is continuously moved within a certain range of angles including the incident angle of the reference beam to generate a reproduction holographic image continuously. The peaks of respective pixels are collected using a plurality of reproduction signals obtained as thus described to produce one reproduction image.

### SUMMARY

According to the method disclosed in Patent Document 1, a plurality of reproduction images are obtained by projecting a reproduction reference beam projected in various ways, and the images are processed into one reproduction image. The method therefore has a problem in that it involves a complicated process which takes a long time to perform. The method is unsuitable for processing of a multiplicity of holographic images in a short time.

Thus, it is desirable to provide a holographic reproduction image processing apparatus and processing method which involve a process that can be performed in a short time and which allow a holographic image to be read with the influence of luminance variation suppressed.

An embodiment of the present disclosure is directed to a holographic reproduction image processing apparatus including a detecting section detecting the luminance of a plurality of pixels in an area of a holographic reproduction image extending in a direction substantially orthogonal to a direction in which the image has luminance variation and an image processing section correcting the luminance variation according to luminance information supplied from the detecting section.

Another embodiment of the present disclosure is directed to a holographic reproduction image processing method, including the steps of: detecting the luminance of a plurality of pixels in an area of a holographic reproduction image extending in a direction substantially orthogonal to a direction in which the image has luminance variation; and correcting the luminance variation according to luminance information obtained when the detection is performed.

According to the embodiments of the present disclosure, a holographic reproduction image is binarized after correcting luminance variation of the image. Therefore, the binarizing process can be properly performed. Further, there is no need for processing information of a plurality of images to synthesize the images into one image, and image processing can therefore be carried out at a high speed.

### BRIEF DESCRIPTION OF THE DRAWINGS

FIG. 1 is a schematic illustration showing an exemplary configuration of an imaging apparatus in which the technique according to an embodiment of the present disclosure can be used;

FIG. 2 is a schematic illustration for explaining a holographic reproduction image;

FIG. 3 is a block diagram of an exemplary holographic reproduction image processing apparatus;

FIG. 4 is a schematic illustration for explaining blurs in a holographic image;

FIG. 5 is schematic illustrations for explaining an exemplary post process;

FIGS. 6A and 6B are schematic illustrations for explaining the exemplary post process;

FIG. 7 is a schematic illustration for explaining a holographic reproduction image obtained by the process; and

FIG. 8 is a block diagram of an exemplary holographic reproduction image processing apparatus.

### DETAILED DESCRIPTION

Embodiments of the present disclosure will now be described. The following items will be described in the order listed.

<1. First Embodiment>

<2. Second Embodiment>

<3. Modifications>

The embodiments described below are preferred embodiments according to the present disclosure and some technically preferred limitations are incorporated therein, but the scope of the present disclosure is not limited to these embodiments unless otherwise specified.

### 1. First Embodiment

### Hologram Imaging Apparatus

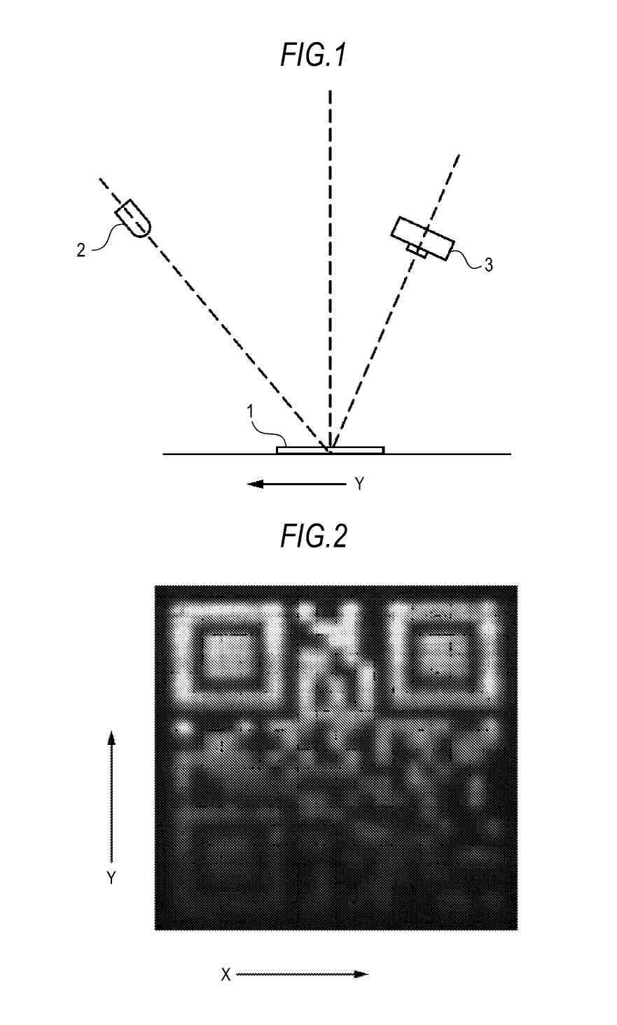

As shown in FIG. 1, a hologram recording medium (e.g., a medium for recording a Lipman hologram) 1 is illuminated with a reference beam from a light source 2 such as an LED (light-emitting diode). An image recorded on the hologram recording medium 1 is reproduced, and the reproduced image is imaged by an imaging apparatus 3. For example, the hologram recording medium 1 is placed on a horizontal surface, and the relationship between the angle of incidence of the reference beam with respect to the normal line of the surface and the angle defined by the normal line and the optical axis of the imaging apparatus is kept equal to the relationship between those angles at the time of recording. The arrow Y indicates the vertical direction of a holographic reproduction image. The disposition of elements shown in FIG. 1 schematically represents a minimum setup required for the embodiment. A plurality of LEDs may be used as the light source 2, and optical elements such as lenses may be provided.

For example, an image generated by coding information, e.g., a one-dimensional bar code, a two-dimensional bar code (e.g., a QR code (registered trademark)), a number such as a serial number, or characters, is recorded on the hologram recording medium 1. A holographic reproduction image obtained by the imaging apparatus 3 may have luminance variation attributable to the stability of the light source 2 and the contraction of the recording material. FIG. 2 shows a holographic reproduction image of a QR code (registered trademark) obtained by the imaging apparatus 3. A QR code has a square shape or the same number of pixels when counted in a horizontal direction X and a vertical direction Y. The number of pixels and the pattern of such a code are prescribed in the relevant standard. FIG. 2 shows a part of one image where a QR code is located.

As shown in FIG. 2, a holographic reproduction image reproduced under the conditions shown in FIG. 1 is characterized in that it has luminance variation in the Y direction attributable to the hologram reproducing conditions. In other words, there is little luminance variation between a plurality of pixels located on each line extending in the horizontal direction when the illuminating light has a uniform luminance distribution. The luminance distribution of the plurality of pixels on each line is checked taking such a characteristic into consideration, and a threshold for binarization is set for the line based on the luminance distribution. The plurality of pixels on the line are binarized using the threshold set as thus described. The correction of the luminance distribution of the illuminating light is not limited to the implementation on each line, and such correction may be simultaneously carried out in areas each of which is formed by a plurality of pixels per line or in blocks which are divisions of one image.

### [Exemplary Imaging Processing Apparatus]

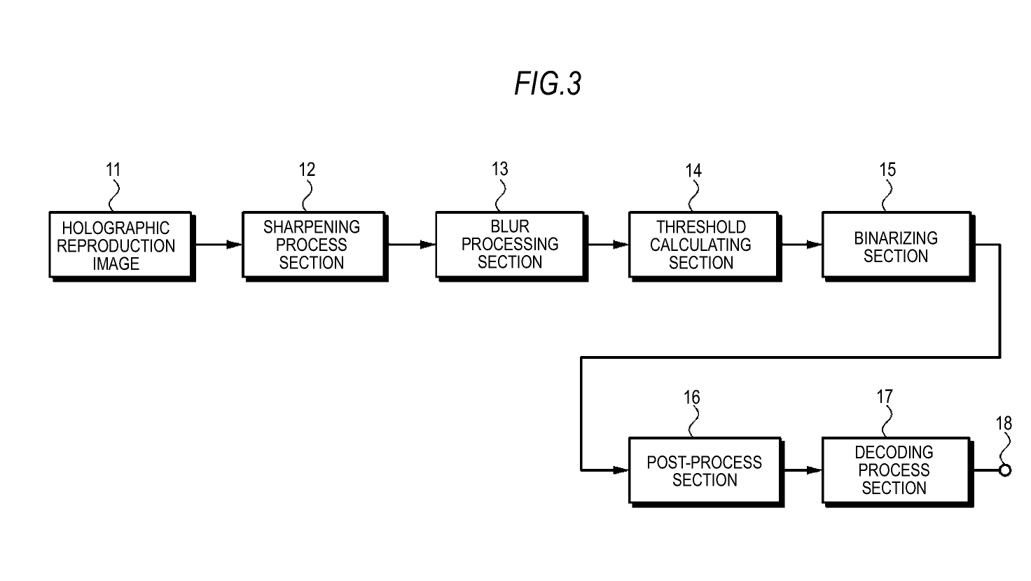

An exemplary image processing apparatus will now be described with reference to FIG. 3. A holographic reproduction image 11 acquired by the imaging apparatus 3 is supplied to a sharpening process section 12. For example, one pixel of the holographic reproduction image 11 represents 8-bit digital image data. The 8-bit digital image data has levels ranging from level 0 to level 255. For example, when a material having a binary (black and white) QR code printed thereon is properly exposed and photographed, a black pixel becomes a level slightly higher than the level 0 (a level corresponding to dark gray), and a white pixel becomes a level slightly lower than the level 255 (a level corresponding to light gray). However, the holographic reproduction image 11 does not necessarily have such levels because of luminance variation and blur unique to holograms.

A holographic reproduction image is supplied to the image processing apparatus by recording the holographic reproduction image, for example, in a removable recording medium and inserting the recording medium in the image processing apparatus. Each block of the image processing apparatus may be implemented on a hardware basis. The image processing apparatus may alternatively be implemented as software processes by installing programs on a microcomputer. Further, the apparatus may be implemented in the form of a mixture of hardware processes and software processes. Alternatively, a raw image may be acquired by the imaging apparatus 3, and the raw image may be processed by the image processing apparatus. Still alternatively, an image signal which has been compressed by the imaging apparatus 3 according to JPEG may be decoded and processed by the image processing apparatus. Although not shown, a display such as a liquid crystal display is provided to display data required for image processing and results of the process.

The sharpening process section 11 performs a process of suppressing blur of an image. For example, prior to the reproduction of the hologram recording medium 1 having a QR code recorded thereon, a holographic image for calibration is generated using the same reproducing apparatus. The holographic image for calibration is an image recorded on a hologram recording medium having the same characteristics as those of the hologram recording medium 1, the image for calibration including a point image provided instead of the QR code in an area corresponding to the area where the QR code is recorded. For example, the point image is an image having high luminance (e.g., the maximum value of 255) constituted by one pixel. Alternatively, an area for recording a point image for calibration may be provided on a hologram having a QR code recorded therein, and the area may be recorded simultaneously with the hologram. When a point image can be recorded on a hologram by displaying one pixel of a spatial light modulator (SLM) included in the hologram recording optical system with high luminance (e.g., the maximum luminance that the SLM can display).

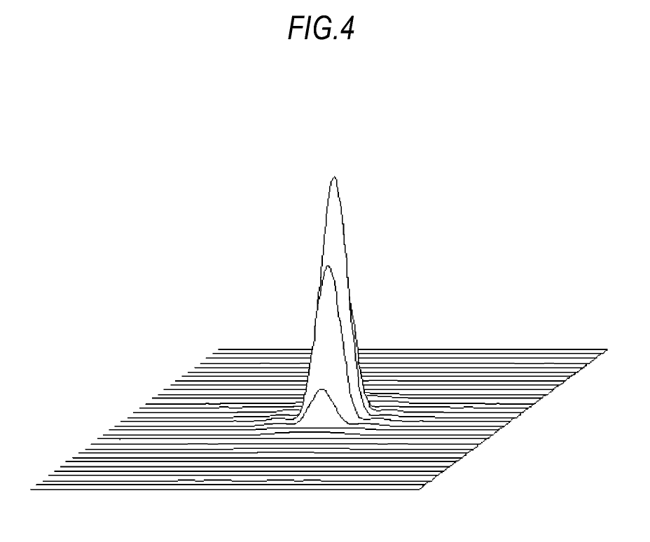

Such a hologram for calibration is reproduced by a reproducing (reading) apparatus as shown in FIG. 1. In the holographic reproduction image for calibration, the point image spreads into a plurality of pixels neighboring the pixel where the image is recorded due to blurring. FIG. 4 represents an example of a PSF (point spread function) representing blurs. Since a PSF represents the spread and level of a point image on an image plane, it may be regarded as a blur function (transfer function). Such blurs include a blur unique to holograms associated with hologram reproducing conditions and a blur originating from an imaging lens.

A point image without blur is created in advance, and the position and level of the image is known. A blur function intervening between such a point image without blur and a blurred image can be identified. For example, the blur function is represented by a two-dimensional digital filter. Therefore, a blurred image can be converted into an image without blur by passing the blurred image through an inverse filter that is the inverse of the digital filter. The coefficient of an inverse filter obtained as thus described is stored in a storage device (which is preferably a non-volatile memory) provided in the sharpening process section 12. When a change is made to the reproduction system or hologram recording medium, the above-described adjustment is repeated.

The use of a holographic image for calibration including a point image recorded therein allows a blur function to be obtained with high accuracy in accordance with a hologram reproduction system that is actually used. Further, a blur function may be approximated by a function such as a two-dimensional isotropic Gaussian function.

Blurs in a holographic reproduction image can be suppressed by the sharpening process section 12. A signal output from the sharpening process section 12 is supplied to a blur processing section 13. The blur processing section 13 is a one-dimensional or two-dimensional digital low-pass filter. Boundaries between pixels of the spatial light modulator used for recording a holographic image may become noticeable after the image is converted into a holographic reproduction image through the sharpening process. Blur processing is carried out to keep such boundaries unnoticeable.

A signal output from the blur processing section 13 is supplied to a threshold calculation section 14. The threshold calculation section 14 calculates a threshold to be used at a binarizing section 15 provided downstream thereof. Since a holographic reproduction image has luminance variation in the Y direction as described above, a threshold is calculated for, for example, each line in the X direction orthogonal to the Y direction.

First, frequency distributions of the values of a plurality of pixels on each line are obtained. The frequency distributions (histograms) of the values of the plurality of pixels thus obtained include two types of peaks, i.e., low levels corresponding to the levels of black or dark gray and high levels corresponding to the levels of white and light gray. A method such as what is called discriminant analysis is carried out using the histograms to determine an optimal threshold. Specifically, the variance of white and black levels defined using each luminance value as a threshold is identified in each frequency distribution, and similar variance between the frequency distributions is identified. A luminance value which minimizes the ratio of the variance in each frequency distribution to the variance between the frequency distributions is determined to be an optimal threshold. This process is performed for each line to determine a threshold for the line adaptively and automatically. The threshold may be determined using methods other than discriminant analysis. A threshold is similarly calculated for each line, and the threshold for each line is stored in a storage section.

A threshold may be calculated for each area extending over several lines instead of calculating a threshold for each line if there is no significant difference in luminance variation between the lines of interest. When an image of a one-dimensional bar code is recorded, since the luminance of the image varies only in the horizontal direction, a threshold may be calculated for each area of the image extending over several lines. Further, a threshold may alternatively be calculated for each of blocks of the image, the blocks having a horizontal size equivalent to the size of equal divisions of one line and a vertical size equivalent to several lines. Significant variation of the illuminance of illumination light can be properly handled by dividing an area of interest also in the horizontal direction.

The binarizing section 15 is connected to the threshold calculating section 14. At the binarizing section 15, the value of each pixel is binarized using the threshold calculated by the threshold calculating section 14. A binary signal representing each pixel by a value at either high level or low level is output from the binarizing section 15. The binary signal is supplied to a post-process section 16. The post-process section performs a morphological process, for example, to eliminate black parts included in a white region of the binary image.

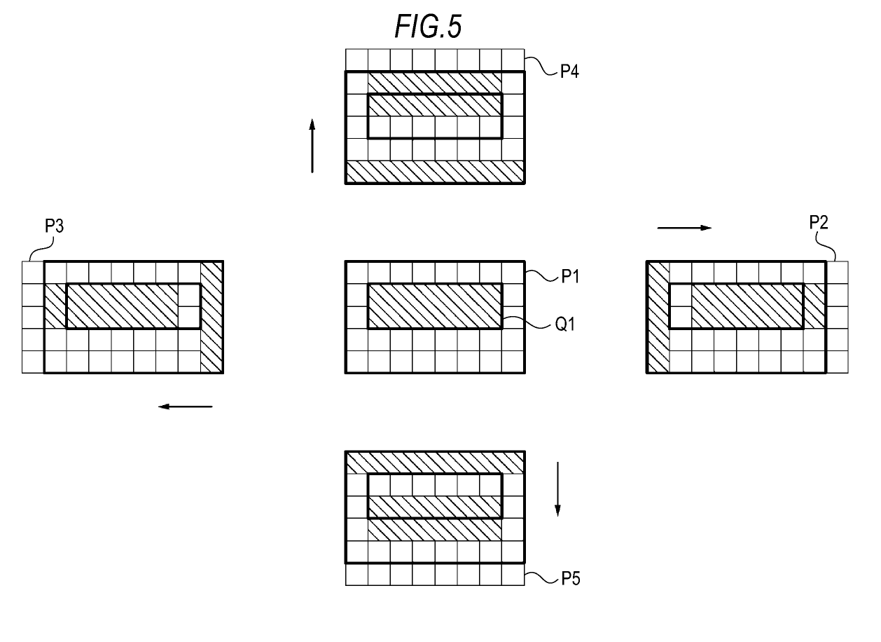

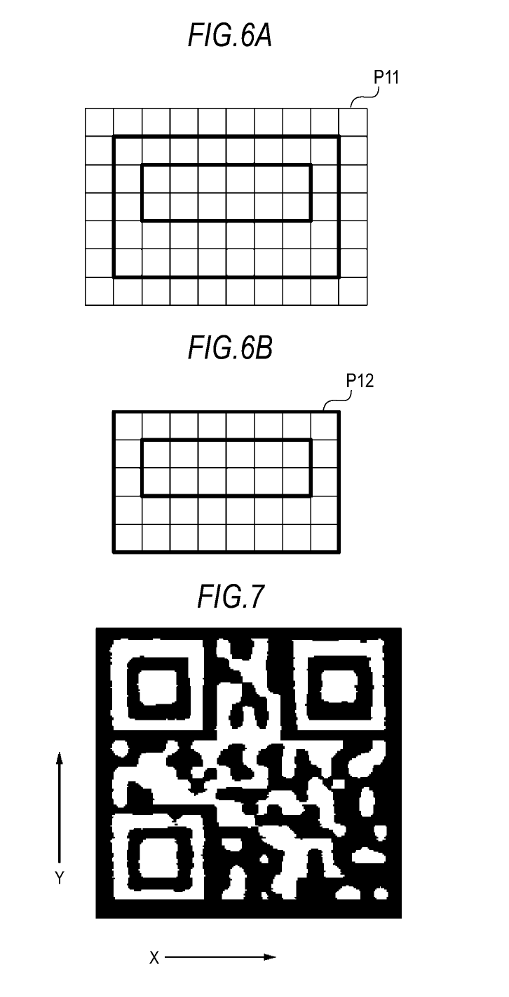

The process performed by the post-process section 16 will now be described with reference to FIGS. 5, 6A, and 6B. The process includes what are called dilation and erosion. Let us assume that a rectangular image P1 having high luminance includes a black area Q1 (the hatched area) as shown in the middle of FIG. 5.

The image P1 is dilated by one pixel rightward in the figure to form an image P2 and dilated by one pixel leftward to form an image P3. Further, the image P1 is dilated by one pixel upward in the figure to form an image P4 and dilated by one pixel downward to form an image P5.

Next, the four images P2 to P5 obtained by dilation are ORed. As shown in FIG. 6A, an image P11 is obtained by the OR operation. Further, the original image P1 is inwardly eroded such that the black area Q1 is filled by the pixels outside the boundaries in the image P1 as shown in FIG. 6B, whereby a processed image P12 is formed. As thus described, a point or the like of low luminance is eliminated from an area of a holographic reproduction image formed by pixels of high luminance.

As a result of image processing as described above, an image of a QR code having luminance variation as shown in FIG. 2 is converted into an image without luminance variation as shown in FIG. 7. Image data output from the post-process section 16 are supplied to a decoding process section 17. The decoding process section 17 decodes information of a holographic reproduction image and outputs the decoded information to an output terminal 18. For example, the decoding process section 17 performs a process of decoding a QR code, and the decoded data are output to the output terminal 18. The decoding process section 17 generates binary data representing a holographic reproduction image from which luminance variation has been eliminated, and the section decodes the binary data. Therefore, decoding errors can be suppressed. While an application of the embodiment to a QR code has been described by way of example, the present technique is also advantageous in cases wherein a one-dimensional bar code or a serial umber formed by numerals and alphabets is recorded in the form of a hologram and wherein image data obtained by imaging the hologram are used on a machine-readable basis.

### 2. Second Embodiment

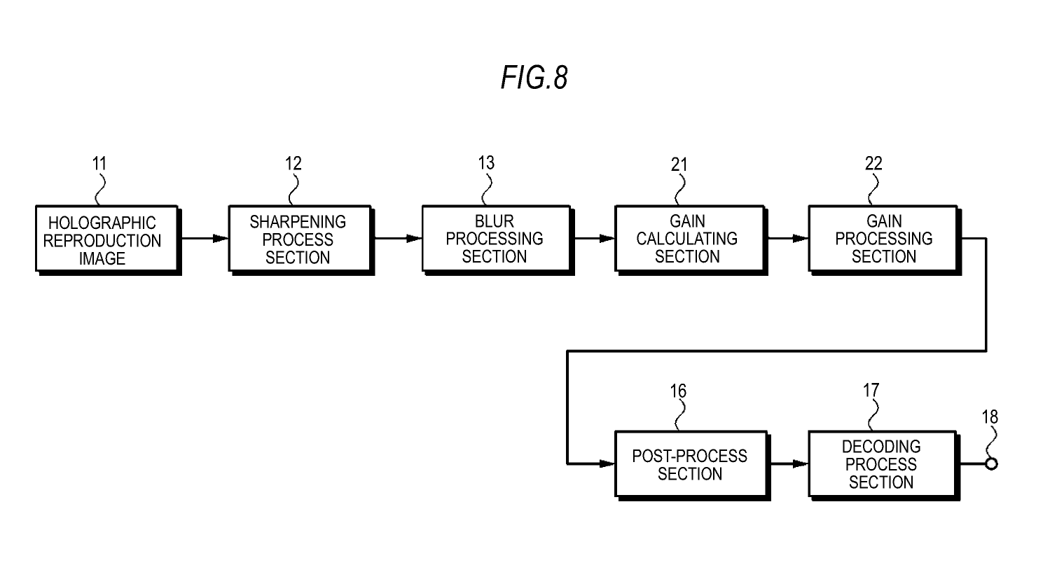

Another example (second embodiment) of an image processing apparatus according to the present disclosure will now be described with reference to FIG. 8. A reproduction apparatus as shown in FIG. 1 is used, and a holographic reproduction image is obtained by an imaging apparatus 3. A holographic reproduction image 11 is supplied to a sharpening process section 12 to suppress blurs in the image. Data output from the sharpening process section 12 are supplied to a blur processing section 13.

The sharpening process section 12 obtains a blur function (filter) using a holographic image for calibration including a point image recorded therein in the same manner as in the above-described embodiment, whereby an inverse filter for correcting blurs is obtained. The holographic reproduction image is passed through the inverse filter to correct blurs in the image. The blur processing section 13 performs low-pass filtering to make pixel boundaries of a spatial light modulator used when recording the hologram unnoticeable.

A signal output from the blur processing section 13 is supplied to a gain calculating section 21, and a signal output from the gain calculating section 21 is supplied to a gain processing section 22. A signal output from the gain processing section 22 is supplied to a decoding process section 17 through a post-process section 16. Decoded data are output from the decoding process section 17 to an output terminal 18. For example, the post-process section 16 performs a process of eliminating a black part included in a white area of a binary image in the same manner as in the first embodiment. The decoding process section 17 decodes information of a holographic reproduction image and outputs resultant data, e.g., a QR code, to the output terminal 18.

The gain calculating section 21 determines a gain for setting the luminance of a plurality of pixels on each line at a proper value to suppress luminance variation of the line. Such a gain may alternatively be calculated for each of regions extending over several lines or each of blocks formed in the same manner as in the description of the first embodiment. The term “proper value” means luminance that is similar to luminance of an image obtained using proper exposure. The proper exposure is defined with respect to the process at the decoding process section 17.

The decoding process section 17 includes a binarizing circuit for binarizing an input image signal. The binarizing circuit is to process digital image signals having proper values within a certain range. For example, when the binarizing circuit of the decoding process section 17 is to process images having luminance information of 8 bits, the condition for imaging an image signal of high luminance at proper exposure is that the signal has a value of about 200 which is about 80% of 255 or the maximum luminance represented by 8 bits. The gain calculating section 21 and the gain processing section 22 are provided to adjust the value of an image signal input to the decoding process section 17 to the proper exposing condition.

The gain calculating section 21 classifies the values of a plurality of pixels on each line into a distribution of high level values and a distribution of low level values using what is called discriminant analysis. A threshold used for the classification is the same value as a threshold used in the binarizing circuit of the decoding process section 17. An average value of high levels (the levels and white and light gray) is calculated, and a calculation is performed to identify a gain to be applied to convert the average value into a high level (e.g., 200) to be obtained at proper exposure. Such a gain calculated for each line is stored in a storage section.

The gain processing section 22 multiplies the value of each pixel by the gain calculated by the gain calculating section 21. At this time, in order to prevent the values of the low level pixels from being increased, only the values of the pixels classified as high levels by the binarization are multiplied by the gain. Further, an average value of the low level pixels may be calculated, and a gain to be applied to convert the average value into a proper low level value may be calculated. The values of the low level pixels may be multiplied by such a gain. Further, an average of the values of all pixels on each line may be calculated, and a gain to be applied to convert the average value into a proper value may be calculated. The values of all pixels may be multiplied by such a gain.

As a result of image processing as described above, luminance variation is eliminated from a holographic reproduction image. Thus, the decoding process section 17 can generate binary data of a holographic reproduction image from which luminance variation has been eliminated. Thus, when the binary data is decoded, decoding errors can be suppressed.

While the embodiment has been described on an assumption that it is implemented on a machine-readable basis, the technique is advantageous when applied to a case wherein character information such as a holographically recorded serial number is read by a human because the technique makes it possible to correct luminance variation attributable hologram reproducing conditions.

### 3. Modifications

Specific embodiments of the present disclosure have been described above, and the present disclosure is not limited to the embodiments, and various modifications may be made. For example, when a holographic reproduction image has luminance variation in the horizontal direction, a threshold may be set for each pixel group formed by a plurality of pixels aligned in the vertical direction, and a gain may alternatively be set for such a pixel group.

The present disclosure contains subject matter related to that disclosed in Japanese Priority Patent Application JP 2010-149571 filed in the Japan Patent Office on Jun. 30, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A holographic reproduction image processing apparatus comprising:
a detecting section detecting the luminance of a plurality of pixels in an area of a holographic reproduction image extending in a direction substantially orthogonal to a direction in which the image has luminance variation; and
an image processing section correcting the luminance variation according to luminance information supplied from the detecting section.

2. A holographic reproduction image processing apparatus according to claim 1, wherein
the detecting section determines a threshold for binarization for each area from the distribution of luminance of the plurality of pixels in the area; and
the image processing section performs binarization using the threshold.

3. A holographic reproduction image processing apparatus according to claim 1, wherein
the detecting section calculates a gain for converting the luminance of the plurality of pixels in each area into a proper value; and
the image processing section multiplies the values of the plurality of pixels in the area by the gain to correct the luminance variation.

4. A holographic reproduction image processing apparatus according to claim 3, wherein the gain is set such that the holographic reproduction image will be rendered as a properly exposed image after the luminance variation is corrected.

5. A holographic reproduction image processing apparatus according to claim 1, further comprising
a sharpening process section, wherein
a holographic image for adjustment including a point image recorded therein is created and reproduced to allow a sharpening process performed by the sharpening process section to be determined in advance based on the reproduced holographic image for adjustment.

6. A holographic reproduction image processing apparatus according to claim 5, wherein a smoothing process section for making pixel boundaries of a spatial light modulator used for recording unnoticeable is connected to the sharpening process section.

7. A holographic reproduction image processing method comprising:
detecting the luminance of a plurality of pixels in an area of a holographic reproduction image extending in a direction substantially orthogonal to a direction in which the image has luminance variation; and
correcting the luminance variation according to luminance information obtained by the detection.

8. A holographic reproduction image processing method according to claim 7, wherein
a threshold for binarization is determined for each area from the distribution of luminance of the plurality of pixels in the area when the detection is performed; and
binarization is performed using the threshold when the image is processed.

9. A holographic reproduction image processing method according to claim 7, wherein
a gain for converting the luminance of the plurality of pixels in each area into a proper value is calculated when the detection is performed; and
the values of the plurality of pixels in the area is multiplied by the gain to correct the luminance variation when the image is processed.
